(19) United States
(12) Patent Application Publication
(10) Pub. No.: US 2009/0273264 A1
(43) Pub. Date: Nov. 5, 2009

(54) FLAPPER MECHANISM FOR A REFRIGERATOR

(76) Inventor: James Christopher Butler, Sidney, OH (US)

Correspondence Address: HARNESS, DICKEY & PIERCE, P.L.C., P.O. BOX 828, BLOOMFIELD HILLS, MI, 48303, US

(21) Appl. No.: 12/114,489

(22) Filed: May 2, 2008

(51) Int. Cl. A47B 96/04; E05D 11/10

(52) U.S. Cl. 312/405; 16/319

(57) ABSTRACT

A refrigerator has a housing and first and second doors. The first door mounted to the housing for rotation about a first pivot axis. The second door is mounted to the housing for rotation about a second pivot axis. The refrigerator further includes a flapper mechanism having a main body portion mounted to the door by at least one hinge member for movement between first position and a second position. The flapper mechanism is movable from the first position to the second position in response to movement of the first door from an open position to a closed position. The flapper mechanism includes a stop member carried by the main body portion. The stop member is biased into engagement with the hinge member to normally maintain the main body portion in the first position.

### INTRODUCTION

The present teachings generally relate to refrigerators. More particularly, the present teachings relate to a flapper mechanism that allows independent articulation of each of a pair of doors mounted for rotation about independent vertically extending pivot axes.

Various refrigerators incorporate side by side doors. Most conventional refrigerators with such doors require a mullion bar against which the doors may be sealed. It is known to provide one of the two doors with a fixed member against which the other door may be sealed. This fixed member requires that the doors of the refrigerator always be opened in a predetermined order. In the regard, the door carrying the fixed member must be closed first and the other door must be opened first. To a more limited extent, it is known to provide one of the doors with a pivoting member that does not require a predetermined order of door operation. In this regard, either of the doors may be closed or opened independent of the orientation of the other door.

While known arrangements may have proven to be acceptable for their intended uses, it remains desirable to provide continuous improvement in the relevant art.

### SUMMARY

According to one particular aspect, the present teachings provide a refrigerator having a housing and first and second doors. The first door is mounted to the housing for rotation about a first pivot axis. The second door is mounted to the housing for rotation about a second pivot axis. The refrigerator further includes a flapper mechanism having a main body portion mounted to the door by at least one hinge member for movement between a first position and a second position. The flapper mechanism is movable from the first position to the second position in response to movement of the first door from an open position to a closed position. The flapper mechanism includes a stop member carried by the main body portion. The stop member is biased into engagement with the hinge member to normally maintain the main body portion in the first position.

According to another aspect, the present teachings provide a flapper mechanism for a refrigerator. The refrigerator has a cabinet and first and second doors mounted to the cabinet. The flapper mechanism includes a main body portion defining a cavity and defining a sealing surface for the second door when the second door is closed. The flapper mechanism further includes at least one hinge member for mounting the main body portion to the first door to articulate between a first position and a second position. The at least one hinge member includes a first hinge member portion disposed in the cavity and coupled to the main body portion for rotation about a hinge pivot axis and a second hinge portion for attachment to the first door. The flapper mechanism further includes a stop member carried by the main body portion. The stop member is disposed in the cavity and biased into engagement with the hinge member to normally maintain the main body portion in the first position.

According to yet another aspect, the present teachings provide a refrigerator including a cabinet, a first door mounted to the housing for rotation about a first pivot axis and a second door mounted to the housing for rotation about a second pivot axis. The refrigerator further includes a flapper mechanism including a main body portion defining a cavity. The main body portion further defines a sealing surface for the second door when the second door is closed. The flapper mechanism further includes at least one hinge member mounting the main body portion to the first door for articulation between a first position and a second position. The at least one hinge member includes a first hinge member portion disposed in the cavity and coupled to the main body portion for rotation about a hinge pivot axis. The at least one hinge member further includes a second hinge portion attached to the first door. The refrigerator further includes a camming element carried by the cabinet for articulating the main body portion from the first position to the second position in response to movement of the first door from an open position to a closed position. The camming element receives a follower member carried by the main body portion of the flapper mechanism.

Further areas of applicability will become apparent from the description provided herein. It should be understood that the description and specific examples are intended for purposes of illustration only and are not intended to limit the scope of the present disclosure.

### DESCRIPTION OF THE DRAWINGS

The present teachings will become more fully understood from the detailed description and the accompanying drawings, wherein:

FIG. 1 is a perspective view of a refrigerator including a flapper mechanism in accordance with the present teachings, one of the doors of the refrigerator shown articulated to a partially open position.

FIG. 2 is an enlarged top view of a portion of the refrigerator of FIG. 1 shown partially in section.

FIG. 3 is an enlarged detail view of the portion of the refrigerator of FIG. 2 shown in circle A.

FIG. 4 is an enlarged cross-sectional view of a portion of the refrigerator of FIG. 1, the refrigerator shown with the doors articulated to closed positions.

FIG. 5 is an enlarged perspective view of an over-center hinge of the flapper mechanism according to the present teachings.

FIG. 6 is an enlarged perspective view of an over-center stop of the flapper mechanism according to the present teachings.

FIG. 7 illustrates an interface between the flapper mechanism and a cam surface carried by the refrigerator, the flapper mechanism shown in section.

### DESCRIPTION OF VARIOUS ASPECTS

The following description of the present teachings is merely exemplary in nature and is in no way intended to limit the invention, its application, or uses.

With general reference to the drawings, an exemplary refrigerator 10 including a flapper mechanism 12 in accordance with the present teachings is illustrated. The refrigerator 10 is illustrated to generally include a housing or cabinet 14. The cabinet 14 may generally define a first storage area 16 and a second storage area (not particularly shown). The first storage area 16 may be a refrigeration compartment and the second storage area may be a freezer compartment. Access to the first storage area or compartment 16 may be provided through first and second doors 18A and 18B. The first and second doors 18A and 18B may be conventionally mounted to the cabinet 14 for articulation about independent pivot axis 20A and 20B, respectively. The pivot axes 20A and 20B may extend in a vertical direction. Access to the second storage compartment may similarly be provided through first and second doors 22A and 22B which pivot about the axes 20A and 20B, respectively.

The flapper mechanism 12 may be carried by one of the first and second doors 18A and 18B. As illustrated, the flapper mechanism 12 may be carried by the first door 18A. In alternate applications, the flapper mechanism 12 may be carried by the second door 18B. It will be understood that either of the first and second doors 22A and 22B may similarly be provided with a substantially identical flapper mechanism 12.

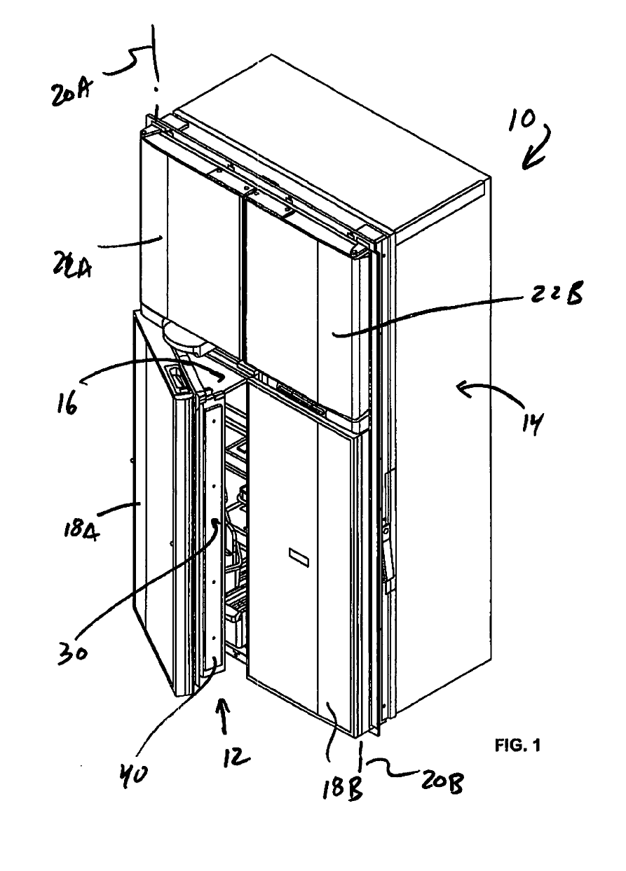

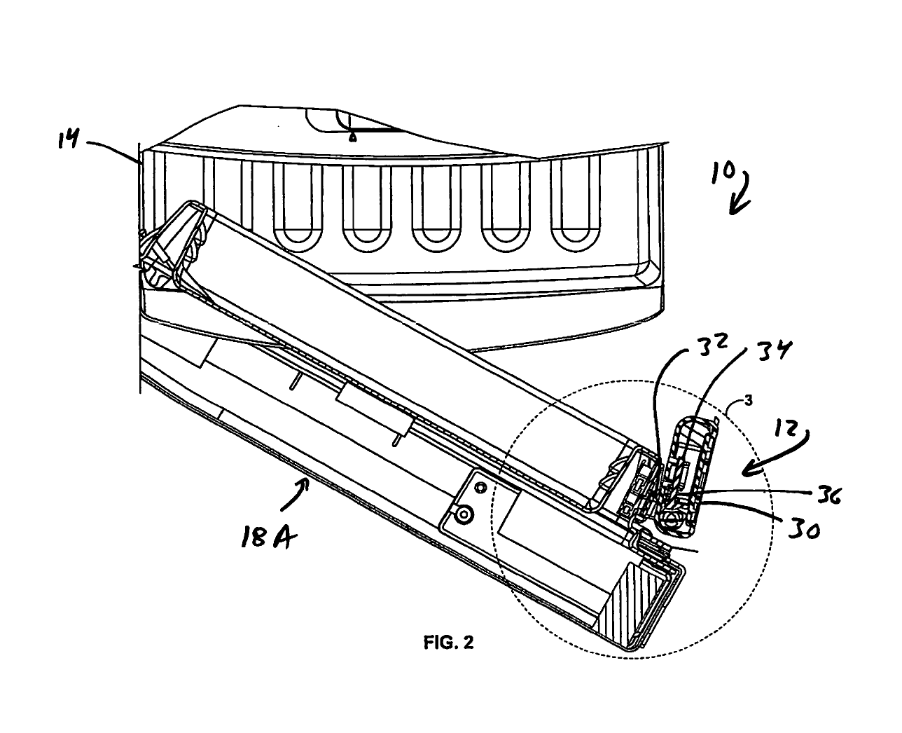

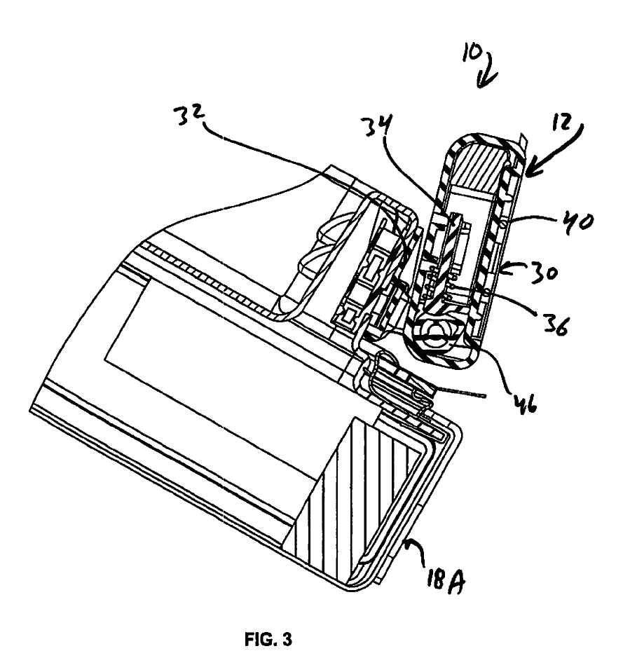

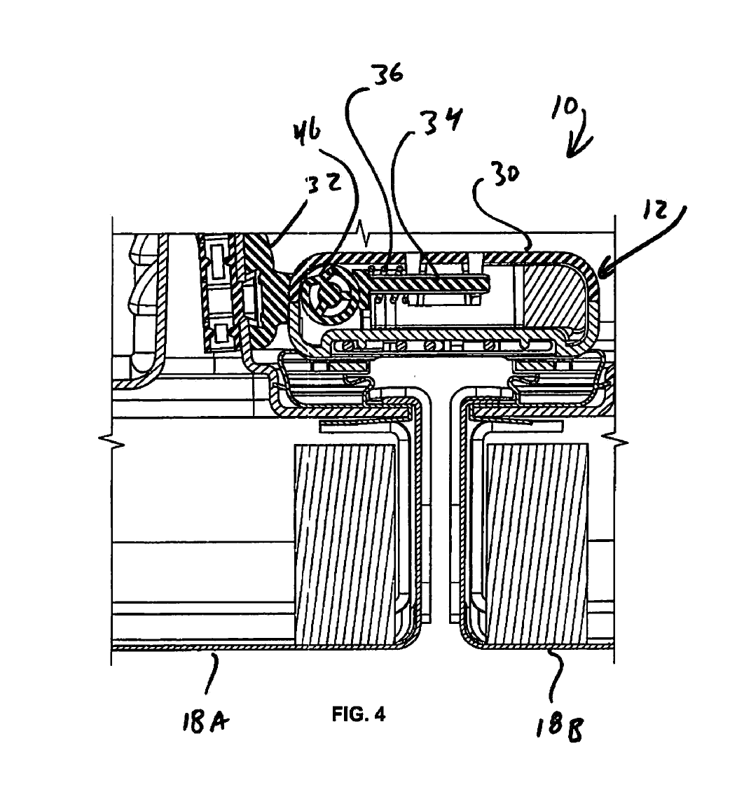

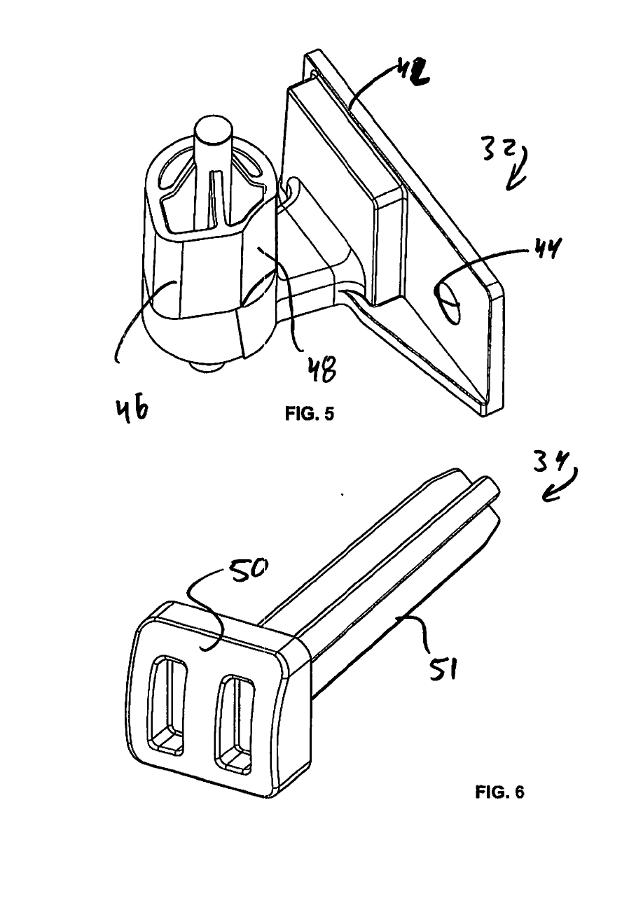

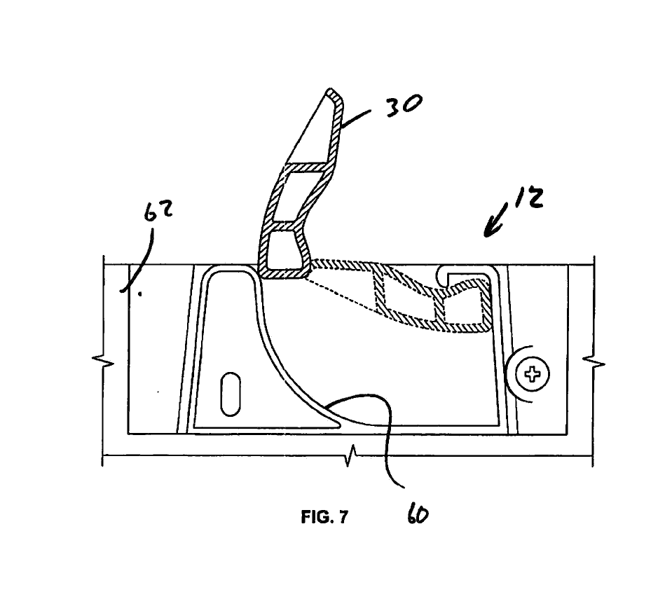

The flapper mechanism 12 may generally include a main body portion 30, a hinge member 32, a stop member 34 and a biasing member 36. The main body portion 30 may be mounted to the first door 18A through one or more hinge members 32 for articulation between a first position or door open position and a second position or door closed position. The first position is shown in FIGS. 1 through 3 and in FIG. 7 in solid lines, for example. The second position is shown in FIG. 4 and in dashed lines in FIG. 7. In the closed position, a surface 40 of the main body portion 30 defines a sealing surface against which the second door 18B may seal.

The hinge member 32 may include a first hinge portion or mounting portion 42 for attachment to the door 18A. In this regard, the mounting portion 42 may define one or more apertures 44 through which fasteners may be received for attachment to the door 18A. The hinge member 32 may be alternatively attached in any other well known manner.

The hinge member 32 may further include a second hinge portion 46 received a cavity defined by the main body portion 30 for relative rotation. The second hinge portion 46 may be formed integrally with the first hinge portion 42. The second hinge portion 46 may define a recess 48. The recess 48 may be in the form of a concave face. The recess 48 receives a head 50 of the stop member 34 to normally maintain the flapper mechanism 12 in the first position. The stop member 34 is biased into engagement with the second hinge portion 46 by the biasing member 36. The biasing member 36 may be in the form of a spring surrounding a shaft 51 of the stop member 34.

The cabinet 14 may carry a camming portion or contoured portion 60 or may otherwise define a camming surface for articulating the flapper member 12 from the first position to the second position upon closing of the first door 18A. The contoured portion 60 may be carried on an underside of a horizontally extending mullion 62 that divides the first compartment 16 from the second compartment. As shown particularly in FIG. 7, the contoured portion 60 defines an arcuate surface that engages the main body portion 30 of the flapper mechanism 12. The main body portion 30 is shown in solid lines upon initial engagement with the contoured portion 60. The main body portion 30 is shown in hidden lines when the door 18A is closed.

With the first door 18A in the open position, the main body portion 30 of the flapper mechanism 12 is in its first position. As the first door 18A articulates toward a closed position, a follower portion of the main body portion 30 engages the contoured portion 60 and the main body portion 30 is moved to its second position against the bias of the stop member 34. When the first door 18A is moved toward the open position, the contoured portion 60 articulates the main body portion 30 to its first position. The stop member 34 engages the second hinge portion 46 and normally maintains the main body portion 30 in the first position.

While specific examples have been described in the specification and illustrated in the drawings, it will be understood by those skilled in the art that various changes may be made and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

1. A refrigerator comprising:
a housing;
a first door mounted to the housing for rotation about a first pivot axis;
a second door mounted to the housing for rotation about a second pivot axis;
a flapper mechanism having a main body portion mounted to the door by at least one hinge member for movement between first position and a second position, the flapper mechanism movable from the first position to the second position in response to movement of the first door from an open position to a closed position, the flapper mechanism including a stop member carried by the main body portion, the stop member biased into engagement with the hinge member to normally maintain the main body portion in the first position.

2. The refrigerator of claim 1, wherein the first and second pivot axes are vertical extending axes.

3. The refrigerator of claim 1, wherein the main body defines a sealing surface for the second door when the second door is closed.

4. The refrigerator of claim 1, wherein the hinge member defines a recess for receiving a head of the stop member when the main body portion of the flapper is articulated to the first position.

5. The refrigerator of claim 1, further comprising a biasing member for biasing the stop member.

6. The refrigerator of claim 5, wherein the biasing member is a spring surrounding a shaft of the stop member.

7. The refrigerator of claim 1, wherein the hinge member defines a pivot axis about which the main body portion rotates, the pivot axis disposed within a cavity defined by the main body portion.

8. The refrigerator of claim 4, wherein the hinge member includes a first portion attached to the first door and a second portion disposed within a cavity of the main body portion, the second portion defining a pivot axis about which the main body portion rotates.

9. The refrigerator of claim 8, wherein the second portion defines the recess.

10. A flapper mechanism for a refrigerator, the refrigerator having a cabinet and first and second doors mounted to the cabinet, the flapper mechanism comprising:
a main body portion defining a cavity, the main body portion further defining a sealing surface for the second door when the second door is closed;
at least one hinge member for mounting the main body portion to the first door to articulate between a first position and a second position, the at least one hinge member including a first hinge member portion disposed in the cavity and coupled to the main body portion for rotation about a hinge pivot axis, the at least one hinge member further including a second hinge portion for attachment to the first door; and
a stop member carried by the main body portion, the stop member disposed in the cavity and biased into engagement with the hinge member to normally maintain the main body portion in the first position.

11. The flapper mechanism for a refrigerator of claim 10, wherein the first hinge member portion defines a recess for receiving a head of the stop member when the main body portion of the flapper is articulated to the first position.

12. The flapper mechanism for a refrigerator of claim 10, further comprising a biasing member for biasing the stop member.

13. The flapper mechanism for a refrigerator of claim 12, wherein the biasing member is a spring surrounding a shaft of the stop member.

14. The flapper mechanism for a refrigerator of claim 10, in combination with the refrigerator.

15. A refrigerator comprising:
a cabinet;
a first door mounted to the housing for rotation about a first pivot axis;
a second door mounted to the housing for rotation about a second pivot axis;
a flapper mechanism including a main body portion defining a cavity, the main body portion further defining a sealing surface for the second door when the second door is closed, the flapper mechanism further including at least one hinge member mounting the main body portion to the first door for articulation between a first position and a second position, the at least one hinge member including a first hinge member portion disposed in the cavity and coupled to the main body portion for rotation about a hinge pivot axis, the at least one hinge member further including a second hinge portion attached to the first door; and
a camming element carried by the cabinet for articulating the main body portion from the first position to the second position in response to movement of the first door from an open position to a closed position, the camming element receiving a follower member carried by the main body portion of the flapper mechanism.

16. The refrigerator of claim of claim 15, further comprising a stop member carried by the main body portion, the stop member disposed in the cavity and biased into engagement with the hinge member to normally maintain the main body portion in the first position.

17. The refrigerator of claim 15, further comprising a biasing member for biasing the stop member.

18. The flapper mechanism for a refrigerator of claim 17, wherein the biasing member is a spring surrounding a shaft of the stop member.
